(19) United States
(12) Patent Application Publication
(10) Pub. No.: US 2023/0017003 A1
(43) Pub. Date: Jan. 19, 2023

(54) DEVICE AND METHOD FOR MONITORING A USE STATUS

(71) Applicant: Robert Bosch GmbH, Stuttgart (DE)

(72) Inventors: Sergej Scheiermann, Reutlingen (DE); Thomas Block, Reutlingen (DE)

(21) Appl. No.: 17/860,915

(22) Filed: Jul. 8, 2022

(30) Foreign Application Priority Data
Jul. 16, 2021 (DE) 10 2021 207 585.1

(51) Int. Cl. G01D 21/02; H04R 1/10

(52) U.S. Cl. CPC G01D 21/02; H04R 1/1016; H04R 1/1041

(57) ABSTRACT

The detection of a use status of an object. To ascertain the use status, i.e., the decision as to whether or not an object is presently in use, using sensor data of multiple sensors provided at the object. For this purpose, in particular, the individual results about the use status may be correlated with one another. When needed, additional sensors may be activated and incorporated in the evaluation.

### FIELD

The present invention relates to a device and to a method for monitoring a use status of an object. The present invention furthermore relates to a portable device including such a device.

### BACKGROUND INFORMATION

Even though the present invention is described hereafter with respect to a headphone, the present invention is not limited to such a headphone. Rather, the ascertainment according to the present invention of a use status may be applied to any arbitrary portable device.

Headphones, in particular, so-called in-ear headphones, are enjoying increasing popularity. During use, such headphones may be partially inserted into the ear canal. If the user, in contrast, desires not to use the earphones further, he or she may remove them from the ear canal again in a simple manner. In general, the earphones must be manually deactivated in the process and/or the signal source supplying the audio signals must be manually deactivated by the user.

European Patent No. EP 3 169 081 A2 describes, for example, a system including wirelessly connected earphones. The earphones may play back audio signals, which are based on wirelessly received signals.

### SUMMARY

The present invention provides a device and a method for monitoring a use status of an object, as well as a portable device including a device for monitoring the use status. Advantageous specific embodiments of the present invention are disclosed herein.

The present invention provides for the following:

According to an example embodiment of the present invention, a device for monitoring a use status of an object, including multiple sensors and a control unit. The multiple sensors are each designed to detect a surroundings parameter with the aid of sensors. The sensors are furthermore each designed to provide sensor data which correspond to the respective surroundings parameters detected with the aid of sensors. The control unit is designed to receive the sensor data provided by the multiple sensors. The control unit is furthermore designed to ascertain, for a respective sensor, in each case an individual estimated value for the use of the object, using the respective received sensor data. The control unit is furthermore designed to determine a use status for the object, using a correlation of at least two ascertained individual estimated values.

The present invention furthermore provides:

According to an example embodiment of the present invention, a portable device including a device according to the present invention for monitoring the use status, the device for monitoring the use status being designed to ascertain a use status of the portable device.

Finally, the present invention provides:

According to an example embodiment of the present invention, a method for monitoring a use status of an object, including a step for detecting sensor values of multiple sensors. The individual sensors are each designed to provide a sensor value, which corresponds to a surroundings parameter monitored with the aid of sensors. The method furthermore includes a step for ascertaining individual estimated values for the use of the object. The individual estimated values are, in particular, ascertained using the sensor data of the particular sensor. Finally, the method includes a step for determining a use status for the object. The use status of the object may, in particular, be determined using a correlation of at least two ascertained individual estimated values.

The present invention is based on the finding that, in particular, portable objects, such as for example earphones, are not permanently used without interruption. Rather, a user may, for example, temporarily set such an object aside. While such a device is set aside, i.e., not being actively used, such a device may be at least partially deactivated. For this purpose, it is desirable to automatically recognize the use status of such an object. In particular, it is desirable to implement a reliable detection of the instantaneous use status. Since such portable devices are, in general, supplied with electrical energy with the aid of a battery, it is moreover desirable to implement a monitoring of the use status which is as energy-efficient as possible.

According to the present invention, the use status of a portable object is monitored by evaluating the sensor data of multiple sensors present in the sensor. By using the sensor data of multiple different sensors, the reliability of the detected use status may be enhanced. In particular, through the correlation of multiple different sensors, the reliability of the detected use status may be enhanced.

In addition, for example, initially the use status of the object may be monitored with the aid of one or multiple very energy-efficient sensor(s). If a potential change of the use status is registered based on these very energy-efficient sensors, the reliability of the ascertained use status may thereupon be enhanced by activating one or multiple further sensor(s). Since the further sensor(s) only has/have to be temporarily activated, the energy consumption of the overall system may be reduced, however it nonetheless being possible to achieve a high accuracy for the use status.

In this connection, for example, a use status may be understood to mean an active use of the particular object by a user. For example, a distinction may be made, as the use status of an earphone, between a state in which the earphone is situated at the ear or in the ear canal of the user and a state in which the earphone is situated away from the ear of the user. It is also possible, for example, to assess in the case of an arbitrary portable device as to whether a user is holding the device in his/her hand, for example, for use, or whether the user has set the device aside. Viewed in more general terms, it is thus possible, for example, to distinguish, as the use status, between states in which a user is actively using the particular object or device, and states or positions in which no active use by the user is taking place. The use may, for example, include a playback of audio signals, a display of visual signals, but also arbitrary other actions of the particular device or object.

According to one specific example embodiment of the present invention, the multiple sensors include at least one pressure sensor, a magnetic field sensor, a motion sensor, an acceleration sensor and/or a proximity sensor, in particular, an optical proximity sensor. Pressure sensors may, for example, detect a change in height by evaluating the instantaneous air pressure. In this way, it is possible to establish, for example, whether the object to be monitored is being raised or lowered. As a result of the evaluation of a magnetic field, in particular, of the earth's magnetic field, it is possible, for example, to detect a rotary movement of the object to be monitored. It is also possible to detect movements or movement patterns, which indicate a change in the position or location of the object to be monitored, with the aid of arbitrary further motion sensors or acceleration sensors. With the aid of proximity sensors, in particular, optically based proximity sensors, it is possible to establish, for example, whether the object to be monitored is approaching a user or moving away from a user. For example, a corresponding proximity sensor may thus be utilized to establish whether an earphone is being inserted into the ear canal of a user.

According to one specific example embodiment of the present invention, the multiple sensors include a first group including at least two sensors and a second group including at least one further sensor. In this case, the control unit is designed to initially ascertain a first use status of the object, using a correlation of the sensor data of the first group of sensors. If the first use status thus ascertained already has a high correlation, i.e., the ascertained first use status may be regarded as very reliable, this first use status may be regarded as the use status of the object. If a low correlation of the sensor data of the first group of sensors results for the first use status, i.e., the reliability of the first use status is regarded as low, a second sensor status may be ascertained, using the sensor data of the second group of sensors. For distinguishing as to whether the correlation is regarded as high or low, for example, the calculated correlation for the first use status may be compared to a threshold value.

For the determination of the correlation, for example, a probability for a use status may be calculated in each case based on the sensor data of a sensor. Thereafter, a correlation of the probability values may be calculated. In addition, however, in principle, other ways for ascertaining a correlation of the results from individually ascertained individual results are also possible.

According to one specific example embodiment of the present invention, the control unit is configured to activate or deactivate the sensors of the second group of sensors as a function of the sensor data of the sensors of the first group of sensors. In particular, the sensor(s) of the second group of sensors may only be activated when the sensor data of the second group of sensors are also actually required for the ascertainment of the use status.

According to one specific example embodiment of the present invention, the sensor is or the sensors of the second group of sensors are only activated when a movement of the object has been detected, using the sensor data of the first group of sensors. If, in contrast, the sensor data of the first group of sensors allow the conclusion that the object is at rest, it may be assumed that at present the use status of the object has not changed. In this case, a further consideration of the sensor data of the sensors of the second group is not required.

According to one specific example embodiment of the present invention, the sensors of the first group of sensors include at least one pressure sensor, a magnetic field sensor, a motion sensor and/or an acceleration sensor. Such sensors in general have a relatively low energy consumption. Such sensors may therefore also be actively operated longer-term.

According to one specific example embodiment of the present invention, the sensors of the second group of sensors include at least one proximity sensor. In particular, the sensors of the second group of sensors may, for example, include an optical proximity sensor. Such proximity sensors, in general, make it possible to provide very precise information about the instantaneous use status of an object. However, these sensors, in general, have an increased energy consumption compared to the above-described motion sensors. The energy consumption of the overall system may thus be reduced when such proximity sensors are only temporarily activated, in particular, when needed.

According to one specific example embodiment of the portable device, the portable device includes an earphone, in particular, an in-ear headphone. In this case, the device for monitoring the use status may be designed to ascertain whether or not the earphone or in-ear headphone is presently being worn in or at an ear. If, for example, based on the use status, it is established that corresponding earphones are presently not situated in the ear of a user, the playback of audio signals by such an earphone may be deactivated. Accordingly, the playback of audio signals may be automatically activated, after it has been detected that such an earphone is situated in or at the ear of a user.

The above-mentioned embodiments and refinements may be arbitrarily combined with one another, if useful. Further embodiments, refinements and implementations of the present invention also include not explicitly described combinations of features of the present invention which are described at the outset or hereafter with respect to the exemplary embodiments. In particular, those skilled in the art will also add individual aspects as improvements or supplements to the particular basic forms of the present invention.

### BRIEF DESCRIPTION OF THE DRAWINGS

Further features and advantages of the present invention are described hereafter based on the figures.

FIG. 1 shows a schematic representation of a block diagram of a device for monitoring a use status of an object according to one specific example embodiment of the present invention.

FIG. 2 shows a schematic representation of a flowchart, such as underlies a method for monitoring a use status of an object according to one specific example embodiment of the present invention.

### DETAILED DESCRIPTION OF EXAMPLE EMBODIMENTS

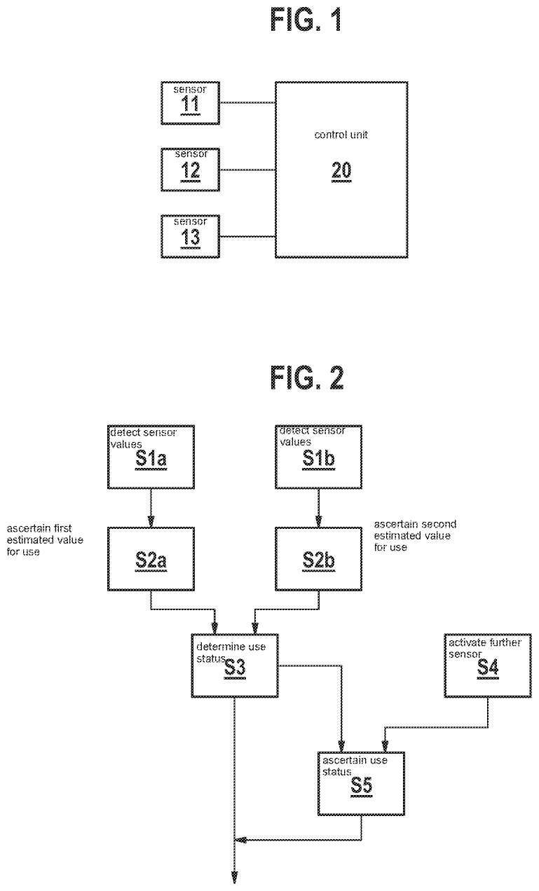

FIG. 1 shows a schematic representation of a block diagram of a device 1 for monitoring a use status of an object. Device 1 includes multiple sensors 11, 12, 13 and a control unit 20. Each of sensors 11 through 13 is designed to monitor at least one surroundings parameter with the aid of sensors and to provide sensor data which correspond to the respective monitored surroundings parameter. For example, sensors 11 through 13 may be pressure sensors, magnetic field sensors, motion sensors, acceleration sensors and proximity sensors.

A pressure sensor may, for example, detect an ambient pressure with the aid of the sensor and provide a sensor signal corresponding to the detected ambient pressure. If, for example, an object including such a pressure sensor is raised, the ambient pressure detected with the aid of the sensor decreases. In this way, a movement may be recognized, provided the height of the object to be monitored changes during this movement. For example, it is possible to recognize in this way whether the object is being raised or lowered. If, for example, the object is placed on a table or floor, the height of the object decreases in the process. In this way, it may be inferred, for example, that, when the object is lowered and an increase in pressure is associated therewith, the corresponding object is no longer being used. Conversely, when the pressure decreases and a raising of the object corresponds thereto, it may be inferred that the object is to be utilized or used.

If one of sensors 11 through 13, for example, is a magnetic field sensor, this magnetic field sensor may be utilized to evaluate the orientations of the sensor and of the object corresponding thereto in the space. Depending on the outer geometry of the object, the corresponding object will, for example during use, have a different spatial orientation than in a state in which the corresponding object is not being used. For example, the loudspeaker membrane of an earphone may preferably have a vertical orientation during use, while the corresponding earphone rather has an at least approximately horizontal orientation when set down on a table or the like.

Furthermore, it is also possible, for example, to utilize acceleration sensors or motion sensors for evaluating the movement of an object in the space. Based on a movement thus detected, in particular, based on an evaluation of the individual parts in the different spatial directions, a change in the use state of an object may thus be inferred. In this way, for example, characteristic movement patterns during the insertion of an earphone, in particular, an in-ear earphone, into the ear canal and during the removal of such an ear phone from the ear canal, may be detected based on the movement pattern. It is also possible, for example, to detect characteristic movement patterns when placing an object on a table or on the floor, and an associated negative acceleration. For example, data of one or multiple movement pattern(s) may be stored in a memory of control unit 20. In this case, control unit 20 may compare an instantaneously identified movement pattern to the stored movement pattern(s), and derive a piece of information about the instantaneous use status from this comparison.

Furthermore, the multiple sensors 11 through 13 may, for example, also include a proximity sensor, such as, for example, an optical proximity sensor or the like. Such a proximity sensor may, for example, be used to detect the proximity of an object in relation to a user. For example, a proximity sensor may be utilized to establish whether an in-ear earphone is situated in or at the ear of a user. In addition, however, arbitrary other sensors are also possible, which supply a sensor signal which may be utilized to establish whether or not an object is being used by a user. For example, a temperature sensor may detect a temperature which corresponds to the body temperature of a user, to establish that a user is presently utilizing the corresponding object, for example holding it in his/her hand or has inserted an earphone into the ear canal.

The above-described as well as the further possible sensors may each have different advantages and disadvantages. For example, some sensors, such as, for example, pressure sensors or acceleration sensors, may have a very low energy demand. Such sensors are thus particularly well-suited for a permanent or at least longer-term operation. However, sensor signals from such sensors having a relatively low energy demand very frequently are only conditionally suitable for providing reliable information about an instantaneous use status of the object. On the other hand, for example, very good information may be provided with the aid of a proximity sensor as to whether an object is situated at a position suitable for a use. For example, it is possible to analyze very reliably with the aid of a proximity sensor whether an in-ear earphone is situated within the ear canal of a user. However, such proximity sensors in general have a relatively high energy demand.

To therefore also ascertain information which is as precise as possible about an instantaneous use state of an object with a relatively low energy demand, control unit 20 merges the sensor signals of multiple surroundings sensors. In particular, at least some of sensors 11 through 13 may thus be temporarily deactivated in the process. In this way, the energy demand may be lowered. If, for example, it is not possible to provide reliable information about an instantaneous use state of an object based on the sensor data of one or multiple sensor(s) having low energy demand, which are permanently active, control unit 20 may additionally activate one or multiple further sensor(s) 11 through 13. Thereupon, the precision of the information about the instantaneous use status of the object may be increased by evaluating the additional sensor signals of the further sensors 11 through 13.

The basic principle for determining the use status of an object is explained hereafter in greater detail based on the example of an in-ear earphone, using a pressure sensor 11, an acceleration sensor 12 and a proximity sensor 13. This example, however, only serves to explain the basic principle according to the present invention and does not represent a limitation of the present invention to the described sensors and/or to an earphone.

In the basic state, for example, pressure sensor 11 and acceleration sensor 12 may be active. In the process, pressure sensor 11 supplies sensor data which correspond to the ambient pressure. Based on these sensor data of pressure sensor 11, control unit 20 is able to recognize a change in pressure. Such a pressure change is an indication of a change in height. If, for example, the earphone is raised by a user and guided to the ear, the ambient pressure decreases in the process. If, conversely, an earphone is placed on a table from the height of the user's head, the earphone is lowered in the process, which may be registered as a pressure increase in the corresponding sensor data.

Furthermore, a characteristic movement pattern which corresponds to a raising of an earphone from the table may, for example, be detected from the sensor data of an acceleration sensor 12. Control unit 20 may also, for example, detect a characteristic movement pattern which corresponds to the insertion of an earphone into the ear canal of a user. Such movement patterns indicate a possible use of the earphone. Furthermore, control unit 20 may derive characteristic movement patterns which correspond to the earphone being pulled out of the ear canal from the sensor data of an acceleration sensor 12. Such a movement pattern during the insertion of the earphone into the ear canal or when pulling it out of the ear canal is, in general, associated with characteristic horizontal accelerations. Characteristic movement patterns when raising an earphone off the table or when placing an earphone down on the table, in contrast, are in general associated with typical vertical accelerations. Based on such characteristic acceleration/movement patterns, a possible use of an earphone or the end of the use of an earphone may thus also be inferred.

However, since air pressure fluctuations or variations in the horizontal or vertical acceleration may also occur during a normal use of an earphone, it is generally not sufficient to solely evaluate the sensor data of such a pressure sensor 11 or acceleration sensor 12. For example, similar variations in the sensor data may also occur when jumping or during very fast movements of a user.

To increase the reliability during the ascertainment of the use status of an object, such as the earphone described here, control unit 20 thus evaluates the sensor data of multiple sensors 11 through 13. For example, control unit 20 may initially permanently evaluate pieces of the sensor data of pressure sensor 11 and acceleration sensor 12 individually, and in the process ascertain a possible probability for an instantaneous use of the object to be monitored. In addition to the calculation of a probability, arbitrary other variables which provide information about the instantaneous use of the object to be monitored are, of course, also possible. Furthermore, control unit 20 may correlate the individually calculated variables for the use status based on the individual sensors 11 and 12 with one another. If there is a high correlation for the ascertained use status of the object to be monitored, the use status thus ascertained may be regarded as an active use status for the object.

If, in contrast, there is a low correlation based on the sensor data of the individual sensors 11 and 12, control unit 20 may also evaluate data of one or multiple additional sensor(s) 13. For example, control unit 20 may activate a proximity sensor 13 and thereupon evaluate the sensor data of this additionally activated proximity sensor 13. As was already described above, such a proximity sensor 13 supplies sensor data which allow the instantaneous use status to be ascertained with high reliability. However, since proximity sensor 13 is activated only when needed, the energy demand of the overall system may be decreased.

Alternatively, it is also possible that control unit 20 initially monitors an instantaneous state of the object to be monitored with the aid of pressure sensor 11 and/or acceleration sensor 12. If the sensor data of at least one of sensors 11 and 12 indicate that the use status of the object to be monitored could have changed, one or multiple further sensor(s) 13 may thereupon be activated. Thereafter, an instantaneous use status of the object may be ascertained based on the sensor data, in particular, by combining the sensor data of multiple sensors 11 through 13 or correlating the results from the individual evaluation of the data of sensors 11 through 13.

The information about the use status of the object may thereupon be utilized for arbitrary suitable actions. For example, device 1 for monitoring the use status may transfer the information about the ascertained use status to an arbitrary further component. The transfer may, in particular, take place wirelessly, but generally also by wire. For example, a function of the object may be completely or partially activated or deactivated as a function of the ascertained use status. For example, the playback of audio signals may be automatically activated for an earphone when it has been detected that the earphone is in use, i.e., rest against the ear or have been inserted into the ear canal. Conversely, a playback of audio signals may be automatically deactivated when the earphone is being removed from the ear. Accordingly, for example in the case of a device including a display unit, the display may be automatically deactivated when it is established that the corresponding object is no longer in use. If necessary, it is also possible to only reduce the brightness of the display to lower the energy demand. Conversely, the display may be activated or the brightness of the display may be increased when it is established that the object including the display is used by a user.

FIG. 2 shows a schematic representation of a flowchart, such as underlies a method for monitoring a use status for an object. In steps S1a and S1b, sensor values of multiple sensors are detected. In step S1a, for example, sensor values of a first sensor may be detected, and in step S1b, sensor values of one or multiple further sensor(s) may be detected. In steps S2a and S2b, individual estimated values for the use of the object are in each case ascertained, using the sensor data of the sensors. In step S2a, for example, a first estimated value for the use of the object may be ascertained, using the sensor data ascertained in step S1a. Similarly, in step S2b, a second individual estimated value for the use of the object may be ascertained, using the sensor data ascertained in step S1b.

Thereupon, in step S3, a use status may be determined for the object. For this purpose, in particular, a correlation of the estimated values, previously ascertained in steps S2a and S2b, for the use of the object may be calculated. If there is a high correlation, i.e., a correlation above a predefined threshold value, the ascertained use status may be used as an instantaneous use status for the object.

If, in contrast, there is a low correlation of the individually calculated estimated values for the use of the object, a further sensor may be activated in step S4. In step S5, thereupon the use status of the object may be ascertained, using sensor data of the further sensor activated in step S4.

In addition, the method may, of course, include arbitrary further steps, such as were described above in connection with device 1 for monitoring the use status. Similarly, the above-described device 1 for monitoring the use status may, of course, also include arbitrary further components, such as are necessary for implementing the method described here.

In summary, the present invention relates to the detection of a use status of an object. In particular, it is provided to ascertain the use status, i.e., the decision as to whether or not an object is presently in use, using sensor data of multiple sensors provided at the object. For this purpose, in particular, the individual results about the use status may be correlated with one another. When needed, additional sensors may be activated and incorporated in the evaluation.

1.-10. (canceled)

11. A device for monitoring a use status of an obj ect, comprising:
multiple sensors which are each configured to detect a respective surroundings parameter and to provide sensor data which correspond to the respective surroundings parameter; and
a control unit configured to receive the sensor data provided by the multiple sensors, to ascertain, using the received sensor data of each sensor, a respective individual estimated value for the use of the object using the received sensor data of the sensor, and to determine the use status for the object using a correlation of at least two ascertained respective individual estimated values.

12. The device as recited in claim 11, wherein the multiple sensors include a pressure sensor, and/or a magnetic field sensor, and/or a motion sensor, and/oran acceleration sensor and/or a proximity sensor and/or an optical proximity sensor.

13. The device as recited in claim 11, wherein the multiple sensors include a first group including at least two sensors and a second group including at least one further sensor, and the control unit is configured to ascertain a first use status, using a correlation of the sensor data of the first group of sensors, and to ascertain a second use status as a function of the ascertained first use status, using the sensor data of the second group of sensors.

14. The device as recited in claim 13, wherein the control unit is configured to activate or deactivate the sensors of the second group as a function of the sensor data of the sensors of the first group.

15. The device as recited in claim 14, wherein the sensors of the second group are activated only when a movement of the object has been detected, using the sensor data of the first group of sensors.

16. The device as recited in claim 13, wherein the sensors of the first group include at least one pressure sensor and/or a magnetic field sensor and/or a motion sensor and/or an acceleration sensor.

17. The device as recited in claim 13, wherein the sensors in the second group include at least one proximity sensor.

18. A portable device, comprising:
a device for monitoring a use status of an object, including:
multiple sensors which are each configured to detect a respective surroundings parameter and to provide sensor data which correspond to the respective surroundings parameter, and
a control unit configured to receive the sensor data provided by the multiple sensors, to ascertain, using the received sensor data of each sensor, a respective individual estimated value for the use of the object using the received sensor data of the sensor, and to determine the use status for the object using a correlation of at least two ascertained respective individual estimated values;
wherein the device for monitoring the use status is configured to ascertain the use status of the portable device.

19. The portable device as recited in claim 18, wherein the portable device includes an in-ear headphone, and the device for monitoring the use status is configured to ascertain whether or not the in-ear headphone is being worn in an ear.

20. A method for parameterizing a use status of an object, comprising the following steps:
detecting sensor values of multiple sensors, each of the multiple sensors being configured to provide a sensor value which corresponds to a surroundings parameter;
ascertaining respective individual estimated values for the use of the object, using respective sensor data of each respective sensor; and
determining the use status for the object, using a correlation of at least two ascertained respective individual estimated values.
